(19) United States
(12) Patent Application Publication
(10) Pub. No.: US 2004/0095335 A1
(43) Pub. Date: May 20, 2004

(54) Touch panel for display device

(75) Inventors: Eui Yeol Oh, Kyonggi-do (KR); Hee Jung Hong, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/704,644

(22) Filed: Nov. 12, 2003

(30) Foreign Application Priority Data
Nov. 14, 2002 (KR) P 2002-70771

(51) Int. Cl. G09G 5/00

(52) U.S. Cl. 345/173

(57) ABSTRACT

A touch panel for a display device including a display device, a touch panel on the display device, a conductive pattern on an upper surface of the touch panel and a conductive member connected to the conductive pattern, and supporting the display device and the touch panel.

This application claims the benefit of Korean Application No. P2002-70771 filed on Nov. 14, 2002, which is hereby incorporated by reference.

### BACKGROUND OF THE INVENTION

1. Field of the Invention

The present invention relates to a touch panel for a display device, and more particularly, a structure for a top surface of a touch panel.

2. Discussion of the Related Art

In order to more efficiently use various electronic machines, touch panels have been generally used to input signals on display surfaces, thereby eliminating additional controls or other types of input devices. Touch panels have been integrated into the display surfaces of flat display devices, such as electronic calculators, liquid crystal display (LCD) devices, plasma display panel (PDP) devices, electroluminescence (EL) devices, and cathode ray tubes (CRTs). By integrating touch panels with display devices, it is possible for a user to select desired information while watching an image displayed on the display device.

Touch panels are capable of sensing when and where a user touches a display surface. Touch-panels may be classified into analog resistive type, capacitive type, EM (Electro-magnetic) type, saw type, and infrared type touch panels. Generally, touch panels are provided with upper and lower transparent substrates, each of the substrates having upper and lower electrodes formed thereon, respectively. The upper and lower transparent substrates are bonded to each other within a predetermined space therebetween. If a surface of the upper transparent substrate is touched at a predetermined point using an input device, such as a finger, a pen or stylus, the upper electrode formed on the upper transparent substrate electrically connects to the lower electrode formed on the lower transparent substrate. A voltage, made variable by a resistance value or a capacitance value of the touched point, is then detected and output along with a location defined by coordinates of the touched point.

In the aforementioned capacitive type touch panel, a film having a transparent electrode is formed on an LCD panel, and a voltage is applied to each comer of the film to generate a uniform electric field in the transparent electrode. Thus, a voltage drop is generated when a predetermined point of a display surface is touched with an input device, such as finger or conductive stylus, such that the coordinates of the touched point can be detected.

The touch panel integrated with the LCD device according to the related art will be described with reference to the accompanying drawings. In the resistive type touch panel integrated with an LCD device, a resistive type touch panel is formed on an LCD module, and the LCD module is integrated with the touch panel by a case top. Hereinafter, the resistive type touch panel integrated with the LCD device will be described in more detail. FIG. 1 is a cross-sectional view illustrating a resistive type touch panel integrated with an LCD device according to the related art.

As shown in FIG. 1, the resistive type touch panel integrated with an LCD device includes an LCD panel 1, upper and lower polarizing plates 2 and 3, a backlight 4, the resistive type touch panel 5, and the case top 9. Upper and lower substrates (not shown) are bonded to each other with a fixed gap in between, and a liquid crystal (not shown) is injected in the gap between the upper and lower substrates to thereby form the LCD panel 1. The LCD panel 1 displays a picture image according to external driving and picture signals. The upper polarizing plate 2 is formed above the LCD panel 1, and the lower polarizing plate 3 is formed under the LCD panel 1, thereby polarizing light passing through them. The backlight 4 uniformly irradiates light upon a rear surface of the LCD panel 1. The resistive type touch panel 5 detects a touched point by output of a voltage level corresponding to the touched point on the LCD panel 1. The case top 9 supports the backlight 4, the LCD panel 1 and the resistive type touch panel 5.

FIG. 2 is a plan view illustrating a resistive type touch panel integrated with the LCD device according to the related art. FIG. 3 is an exploded view illustrating upper and lower substrates of a touch panel according to the related art. As described above in reference to FIG. 1, a touch panel integrated with the LCD device according to the related art is formed on a display surface of the LCD device so that the touch panel may be used to input signal corresponding to where and/or when the display surface is touched.

As shown in FIG. 2, the touch panel includes a viewing area V/A and a dead space region. The viewing area corresponds to the display surface of the display device, and the dead space region D/S/R is formed about the periphery of the viewing area V/A. The upper and lower substrates are bonded to each other in the dead space region D/S/R by an insulating sealant provided in the dead space region D/S/R. When power is provided to the touch panel, and the a point of the touch panel is touched with a pen or finger, a signal line 10 connected to the touch panel in a dummy spacer region has an output of a changed voltage value corresponding to the touched point.

As shown in FIG. 3, the resistive type touch panel 5 includes transparent upper and lower substrates 7 and 6. Spacers 8 are positioned between the upper and lower transparent substrates 7 and 6 for maintaining a predetermined space therebetween, as shown in FIG. 4. Generally, the transparent upper and lower substrates 7 and 6 are formed of Poly Ethylene Terephthalate (PET). A transparent electrode, such as ITO, (not shown in the drawings) having a constant resistance value is formed on a surface (surface opposing the lower substrate) of the upper substrate 7 of the PET film. Metal electrodes 7a are also formed on the transparent electrode of the upper substrate 7 corresponding to lower and upper side dead space regions to provide the power along Y-axis direction. A transparent electrode, such as ITO, (not shown in the drawings) having a constant resistance value is formed on a surface of the lower substrate 6. Further, metal electrodes 6a are formed on the transparent electrode corresponding to left and right side dead space regions to provide the power along X-axis direction. Signal lines 10a and 10b are connected to apply power to the respective metal electrodes 6a and 7a, and to read the voltage of a contact point. The upper and lower substrates 7 and 6 are bonded to each other in the dead space region by an adhesive tape 11. In this state, the upper and lower substrates 7 and 6 are bonded to each other at connection portions between the signal lines 10, 10a and 10b and the metal electrodes 6a and 7a by a conducting adhesive. Generally, the signal lines 10, 10a and 10b are formed of Flexible Printed Cable (FPC).

FIG. 4 is a cross-sectional view illustrating a general touch panel according to the related art. Opposing transparent electrodes are formed on the respective upper and lower substrate 7 and 6. Spacers 8 are disposed on the viewing area V/A for maintaining the predetermined space between the upper and lower substrates. The upper and upper substrates are bonded to each other in the dead space region by the adhesive tape 11.

An operation of the aforementioned resistive type touch panel with the LCD device will be described as follows. A power supply voltage Vcc and a ground voltage GND are applied to upper and lower sides of the transparent electrode printed on the upper substrate 7 via the two signal lines 10a connected to the upper substrate and the metal electrodes 7a. The power supply voltage Vcc and the ground voltage GND are also applied to the left and right sides of the transparent electrode printed on the lower substrate 6 via the two signal lines 10b connected to the lower substrate and the metal electrodes 6a. If the surface of the upper substrate 7 is touched at a point with a stylus or finger, the transparent electrodes (not shown) of the upper and lower substrates become electrically connected to each other at the touched point. Then, a voltage value of the touched point is read via the transparent electrode, the metal electrode 6a and the signal line 10b of the lower substrate 6, so that Y-axis coordinate is detected. In addition, a voltage value is output for the touch point by the transparent electrode, the metal electrode 7a and the signal line 10a of the upper substrate 7, so that X-axis coordinate is detected. Accordingly, the X and Y coordinates of the touch point are detected.

In the alternative, a capacitive type touch panel may be applied to the touch panel integrated with the LCD device instead of the resistive type touch panel. FIG. 5 is a cross-sectional view illustrating the capacitive type touch panel integrated with the LCD device according to the related art. Referring to FIG. 5, the capacitive type touch panel integrated with the LCD device includes an LCD panel 1, upper and lower polarizing plates 2 and 3, a backlight 4, a touch panel 15 and a case top 9. Upper and lower substrates (not shown) are bonded to each other with a gap therebetween. A liquid crystal (not shown) is injected between the upper and lower substrates, thereby forming the LCD panel 1. The LCD panel 1 displays a picture image according to an external driving signal and video signal. Also, the upper polarizing plate 2 is formed on the LCD panel 1, and the lower polarizing plate 3 is formed under the LCD panel 1, thereby polarizing light passing through them. The backlight 4 irradiates uniform light upon a rear surface of the LCD panel 1. The capacitive type touch panel 5 detects a touched point by outputting a voltage value corresponding to the touched point on the LCD panel 1. The case top 9 supports the backlight 4, the LCD panel 1 and the capacitive type touch panel 5.

An operation of the capacitive type touch panel integrated with the LCD device is will be described as follows. As mentioned above, a voltage is applied to generate a uniform electric field in the transparent electrode (not shown) of the touch panel 15, and a point of a display surface is touched with an input device, such as finger or conductive stylus, thereby generating a voltage drop. The voltage drop is detected with a current sensor, and then calculated to sense X-Y coordinates.

The touch panel integrated with the LCD device according to the related art has the following disadvantages. In damp weather, little static electricity can be generated on the human body. However, in a dry weather, a large amount of static charge can be stored on the human body depending upon the type of clothes worn. When a user have a large amount of static charge touches the display surface of the touch panel in dry weather, the static charge may discharge as static electricity into the touch panel and generate noise in the touch panel. As a result, the touch panel may perform an incorrect operation.

### SUMMARY OF THE INVENTION

Accordingly, the present invention is directed to a touch panel for a display device that substantially obviates one or more of the problems due to limitations and disadvantages of the related art.

Another object is to provide a touch panel for a display device that prevents noise from being generated by static electricity.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these objects and other advantages and in accordance with the purpose of the invention, as embodied and broadly described herein, a touch panel for a display device including a display device, a touch panel on the display device, a conductive pattern on an upper surface of the touch panel and a conductive member connected to the conductive pattern, and supporting the display device and the touch panel.

It is to be understood that both the foregoing general description and the following detailed description of the present invention are exemplary and explanatory, and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention.

FIG. 1 is a cross-sectional view illustrating a resistive type touch panel integrated with an LCD device according to the related art.

FIG. 2 is a plan view illustrating a resistive type touch panel integrated with an LCD device according to the related art.

FIG. 3 is an exploded view illustrating upper and lower substrates of a touch panel according to the related art.

FIG. 4 is a cross-sectional view illustrating a resistive type touch panel according to the related art.

FIG. 5 is a cross-sectional view illustrating a capacitive type touch panel integrated with an LCD device according to the related art.

FIG. 6 is a cross-sectional view illustrating a touch panel integrated with an LCD device according to a first embodiment of the present invention.

FIG. 7 is an exploded view illustrating a touch panel integrated with an LCD device according to the first embodiment of the present invention.

FIG. 8 is a cross-sectional view illustrating a resistive type touch panel taken along line I-I′ of FIG. 7 according to the first embodiment of the present invention.

FIG. 9 is a cross-sectional view illustrating a touch panel integrated with an LCD device according to the second embodiment of the present invention.

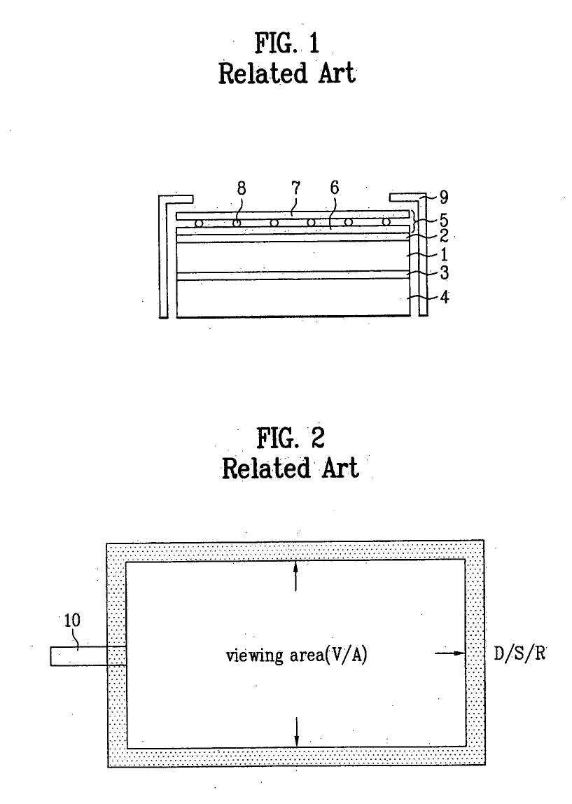

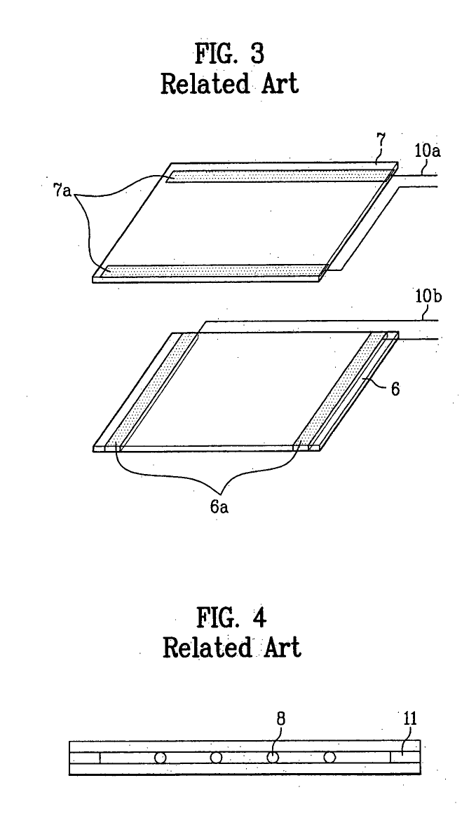

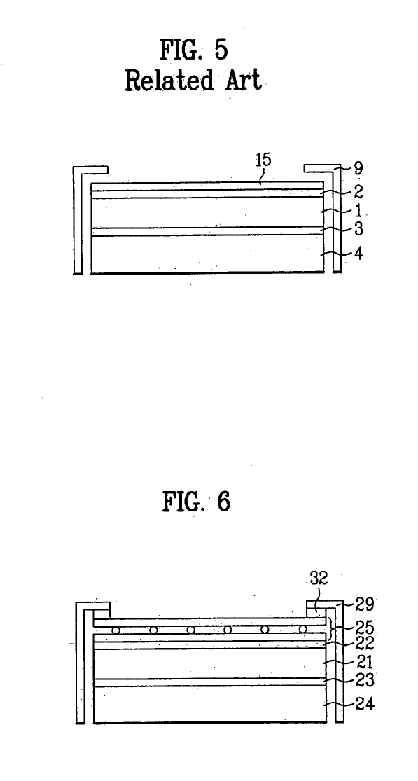

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

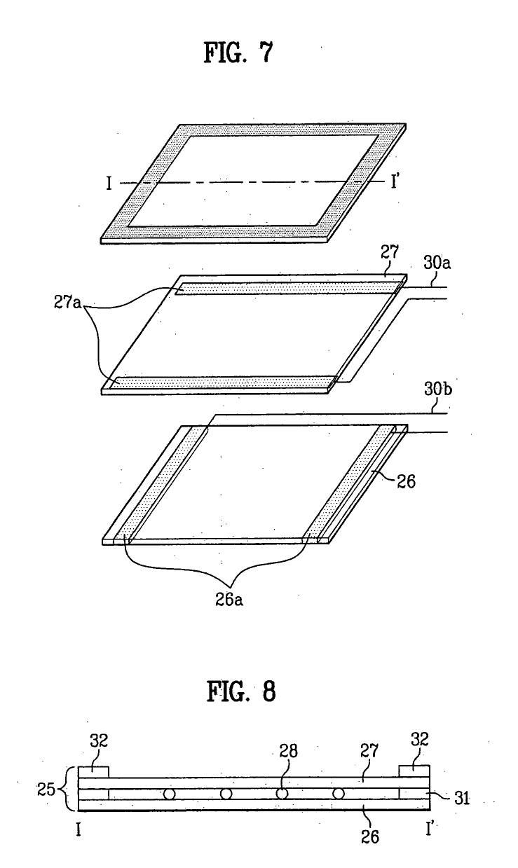

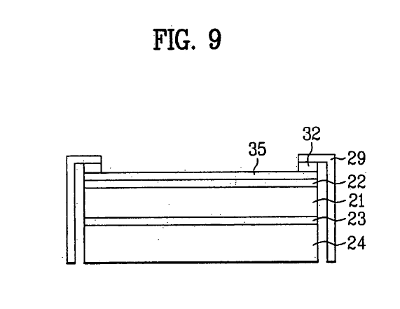

A touch panel for a display device according to embodiments the present invention will be described with reference to FIGS. 6 through 9. More particularly, FIG. 6 is a cross-sectional view illustrating a touch panel integrated with an LCD device according to a first embodiment of the present invention. FIG. 7 is an exploded view illustrating a touch panel integrated with an LCD device according to the first embodiment of the present invention. FIG. 8 is a cross-sectional view illustrating a resistive type touch panel taken along line I-I′ of FIG. 7 according to the first embodiment of the present invention. FIG. 9 is a cross-sectional view illustrating a capacitive type touch panel integrated with an LCD device according to the second embodiment of the present invention.

As shown in FIG. 6, a touch panel integrated with the LCD device according to embodiments of the present invention includes an LCD panel 21, upper and lower polarizing plates 22 and 23, a backlight 24, a resistive type touch panel 25, a conductive pattern 32, and a case top 29. Upper and lower substrates (not shown) are bonded to each other with a fixed gap therebetween. A liquid crystal (not shown) is injected between the upper and lower substrates, thereby forming the LCD panel 21. The LCD panel 21 displays a picture image according to external driving and picture signals. An upper polarizing plate 22 is formed above the LCD panel 21 and a lower polarizing plate 23 is formed under the LCD panel 21. A backlight 24 uniformly irradiates light upon the rear of the LCD panel 21. The resistive type touch panel 25 is formed on the LCD panel 21 for detecting a touched point by outputting a voltage value corresponding to the touched point. A case top 29 supports the backlight 24, the LCD panel 21 and the resistive type touch panel 25. A conductive pattern 32 is formed on the circumference of an upper surface of the resistive type touch panel 25, and the case top 29 is connected to the conductive pattern 32.

As shown in FIG. 8, a resistive type touch panel 25 according embodiments of the present invention is provided with transparent upper and lower substrates 27 and 26 including PolyEthylene Terephthalate (PET) film, and spacers 28 between the upper and lower substrates for maintaining a fixed interval between the upper and lower substrates. As shown in FIG. 7, a transparent electrode (ITO, not shown in the drawings) having a constant resistance value is formed on a surface (surface opposing the lower substrate) of-the upper substrate 27 of the PET film, and a metal electrode 27a is formed on the transparent electrode corresponding to upper and lower side dead space regions to provide a power along Y-axis direction. Also, the transparent electrode (ITO, not shown in the drawings) having the constant resistance value is formed on a surface of the lower substrate 26, and a metal electrode 26a is formed on the transparent electrode corresponding to left and right side dead space regions to provide the power along X-axis direction. The conductive pattern 32 is formed at a periphery of the surface that does not have the transparent electrode or the metal electrode 27a.

If static electricity discharges from a finger when the finger is touched at a point of the touch panel 25, the conductive pattern 32 discharges the static electricity to the case top 29. Accordingly, it is preferable to form the conductive pattern 32 only in the dummy space region when the conductive material is opaque. In the case of the conductive pattern 32 being formed of a transparent metal material, it is not necessary to form the conductive pattern 32 in the dummy space region. Signal lines 30a and 30b are connected for applying the power to the respective metal electrodes 26a and 27a, and reading a voltage of a contact point.

Spacers 28 are dispersed on the lower substrate 26, and then the upper and lower substrates 27 and 26 are bonded to each other in the dead space region by an adhesive tape 31. More particularly, the upper and lower substrates 27 and 26 are bonded to each other at connection portions between the signal lines 30a and 30b and the metal electrodes 26a and 27a by a conducting adhesive. Generally, the signal lines 30a and 30b are formed of Flexible Printed Cable (FPC).

Although not shown, when a glass type substrate is used for the resistive type touch panel 25, the conductive pattern 32 is formed in the periphery of the display surface of the touch panel 25, and the conductive pattern 32 is connected to a system case instead of the case top. At this time, the case top or system case is formed of a conductive material.

An operation of the touch panel integrated with the LCD device according to the first embodiment of the present invention will be described as follows. A power supply voltage Vcc and a ground voltage GND are applied to upper and lower sides of the transparent electrode printed on the upper substrate 27 via the two signal lines 30a connected to the upper substrate and the metal electrodes 27a. The power supply voltage Vcc and the ground voltage GND are also applied to the left and right sides of the transparent electrode printed on the lower substrate 26 via the two signal lines 30b connected to the lower substrate and the metal electrodes 26a. If the surface of the upper substrate 27 is touched at the predetermined point with a pen or finger, the transparent electrodes (not shown) of the upper and lower substrates become electrically connected to each other at the touch point. Then, a voltage value of the contact point is output via the transparent electrode, the metal electrode 26a and the signal line 10b of the lower substrate 26, so that Y-axis coordinates are sensed. In addition, another voltage value of the contact point is output via the transparent electrode, the metal electrode 27a and the signal line 30a of the upper substrate 27, so that X-axis coordinates are sensed. Thus, the X-Y coordinates of the contact point are sensed.

When a user touches a point of the touch panel with a finger in a dry weather, the static electricity may be discharged from the user. Although the static electricity may be discharged, the static electricity discharged will be lead to ground via conductive pattern 32 through the top case 29 or the system case (not shown in the drawings), thereby preventing noise from being generated. As a result, it is possible to prevent incorrect operation of the touch panel due to a static electricity discharge.

In the alternative, a capacitive type touch panel may be applied to the touch panel integrated with the LCD device instead of the resistive type touch panel. FIG. 9 is a cross-sectional view illustrating a capacitive type touch panel integrated with an LCD device according to a second embodiment of the present invention. The capacitive type touch panel integrated with the LCD device according to the second embodiment of the present invention includes an LCD panel 21, upper and lower polarizing plates 22 and 23, a backlight 24, a capacitive type touch panel 35, a conductive pattern 32, and a case top 29. The upper and lower substrates are bonded to each other with a fixed gap therebetween. A liquid crystal is injected into the gap between the upper and lower substrates, thereby forming a LCD panel 21 for displaying a picture image according to external driving and picture signals.

As shown in FIG. 9, an upper polarizing plate 22 is formed above the LCD panel 21 and a lower polarizing plate 23 is formed under the LCD panel 21 such that light passing through the plates is polarized. A backlight 24 uniformly irradiates light upon the rear of the LCD panel 21, and the capacitive type touch panel 35 is formed on an upper surface of the LCD panel for detecting a touched point by outputting a different voltage according to the touched point. Then, the conductive pattern 32 is formed on the circumference of an upper surface of the capacitive type touch panel 35, and the case top 29 is grounded on the conductive pattern 32, and supports the backlight 24, the LCD panel 21 and the capacitive type touch panel 35.

In the capacitive type touch panel 35, transparent electrodes are deposited on rectangular-shaped transparent substrates of PET film, and metal electrodes are formed on the transparent electrode corresponding to each comer of the substrate to form a uniform electric field. If a glass substrate is used instead of the substrate of PET film, a system case is grounded on the conductive pattern 32.

An operation of the capacitive type touch panel integrated with the LCD device according to the second embodiment of the present invention will be described as follows.

As mentioned above, a voltage is applied to generate a uniform electric field in the transparent electrode (not shown) of the capacitive type touch panel 35. When a point of a display surface is touched with an input device, such as finger or conductive stylus, a voltage drop is created. Then, the voltage drop is detected with a current sensor, and then calculated to sense X-Y coordinates.

Even though static electricity is discharged when touching the capacitive type touch panel 35 with a finger or stylus, the static electricity is conducted to ground via the conductive pattern through the case top 29 or the system case (not shown). Thus, noise due to a static electricity discharge is prevented from being applied to the current sensor. As a result, it is possible to prevent incorrect operation of the touch panel due to the discharge of static electricity.

In addition, the touch panel according to the present invention may be applied to CRT, PDP and EL display devices. For example, when the touch panel is formed on a CRT, PDP and EL display devices, the conductive pattern is formed at the periphery of the upper surface of the touch panel. The conductive pattern is connected to the metal material, such as the case, thereby preventing noise from being generated by the discharge of static electricity.

As mentioned above, the touch panel integrated with the LCD device according to embodiments of the present invention has the following advantages. First, the conductive pattern is formed at the periphery of the touch panel, and the conductive pattern is connected to the case top or the system case. That is, even though the static electricity is discharged when the user touches a portion of the touch panel with an input device, the static electricity is discharged directly to ground via the top case or the system case, thereby preventing noise from being generated in the touch panel. As a result, it is possible to prevent the incorrect operation of the touch panel.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A touch panel for a display device comprising:
a display device;
a touch panel on the display device;
a conductive pattern on an upper surface of the touch panel; and
a conductive member connected to the conductive pattern, and supporting the display device and the touch panel.

2. The touch panel of claim 1, wherein the display device is a liquid crystal display (LCD) device.

3. The touch panel of claim 2, wherein the LCD device comprising:
an LCD panel displaying a picture image according to external driving and picture signals, the LCD panel having upper and lower substrates bonded to each other with a fixed gap in between, and a liquid crystal layer in the gap between the upper and lower substrates;
an the upper polarizing plate on the LCD panel;
a lower polarizing plate under the LCD panel; and
a backlight uniformly irradiating light upon a rear surface of the LCD panel.

4. The touch panel of claim 1, wherein the touch panel is a resistive type touch panel.

5. The touch panel of claim 1, wherein the touch panel is a capacitive type touch panel.

6. The touch panel of claim 1, wherein the conductive pattern is formed of an indium tin oxide (ITO).

7. The touch panel of claim 1, wherein the conductive pattern is formed of a silver Ag.

8. The touch panel of claim 1, wherein the conductive pattern is formed in the circumference of the surface of the touch panel.

9. The touch panel of claim 1, wherein the display device is one of CRT, PDP and EL display devices.

10. The touch panel of claim 1, wherein the conductive member is a metal case.

11. The touch panel of claim 10, wherein the metal case is a top case of the LCD device.

12. The touch panel of claim 10, wherein the metal case is a system case.
